(19) United States
(12) Patent Application Publication
(10) Pub. No.: US 2013/0283856 A1
(43) Pub. Date: Oct. 31, 2013

(54) System and Method for Securing Fishhooks

(71) Applicant: Melvin Wade Sherrouse, Pearland, TX (US)

(72) Inventor: Melvin Wade Sherrouse, Pearland, TX (US)

(21) Appl. No.: 13/459,322

(22) Filed: Apr. 30, 2012

(51) Int. Cl. A01K 97/00; B23P 11/00

(52) U.S. Cl. 63/1.14; 29/525.01

(57) ABSTRACT

A System and method for Securing Fishhooks is disclosed herein. Specifically, a hook guard system is disclosed. Such hook guard system can comprise a sheet, and a slap bracelet connected to the sheet. The slap bracelet can comprise an insert. Such insert can have a flat state and a curved state. Further, the bracelet can comprise a cover around the insert. Moreover, the sheet and the cover are unibody.

### BACKGROUND

This disclosure relates to a system and method for securing fishhooks.

Historically, fishing was practiced as a source of livelihood, but nowadays it is enjoyed by most as a hobby or as a sport. During transport, fishhooks are often left attached to fishing rods, leaving the hooks exposed. Thus, travelling fishhooks can get caught on things or even people, causing accidents or injuries. Often, fishermen attach the hook to a rod guide ring to make sure the hook stays in place. However, this method often results in entanglement of the hook with other rods and still fails to eliminate the possibility of injury.

Another typical practice during transport is removing the hook and the sinker from the fishing rod. However, this method is still inefficient, as it can be time-consuming, inconvenient and require more effort for the fisherman to constantly remove and reapply the hook.

As such it would be useful to have an improved system and method for securing fishhooks.

### SUMMARY

A system and method for securing fishhooks is disclosed herein. Specifically, a hook guard system is disclosed. Such hook guard system can comprise a sheet, and a slap bracelet connected to the sheet. The slap bracelet can comprise an insert. Such insert can have a flat state and a curved state. Further, the bracelet can comprise a cover around the insert. In one embodiment, the sheet and the cover can be unibody.

Additionally, a method for securing fishhooks is disclosed. The method can comprise wrapping a hook in a hook guard, wherein such hook guard can further comprise a sheet, and a slap bracelet connected to the sheet. The slap bracelet can comprise an insert. Such insert can have a flat state and a curved and state. Further, the bracelet can comprise a cover around the insert. Moreover, the sheet and the cover are unibody.

### BRIEF DESCRIPTION OF THE DRAWINGS

FIG. 1A illustrates a hook guard attached to a fishing rod.

FIG. 1B illustrates a close up view of a hook guard.

FIG. 2A illustrates a partially exploded view of a hook guard.

FIG. 2B illustrates a hook guard in a curved state.

FIG. 2C illustrates an embodiment of a hook guard wherein hook guard further comprises a rigid support.

FIG. 3A illustrates an embodiment of a hook guard in a flat state, wherein the hookguard comprises one slap bracelet on the end of a sheet.

FIG. 3B illustrates an embodiment of a hook guard in a flat state, wherein the hookguard comprises one slap bracelet on the end of a sheet.

FIG. 4B illustrates an embodiment of a hook guard in a curved state.

FIG. 5 illustrates an embodiment of a hook guard wherein one or bracelets are attached on outer edges of a sheet to form a solid, singular body covering around a fishing rod.

### DETAILED DESCRIPTION

Described herein is a system and method for securing a fishhook. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

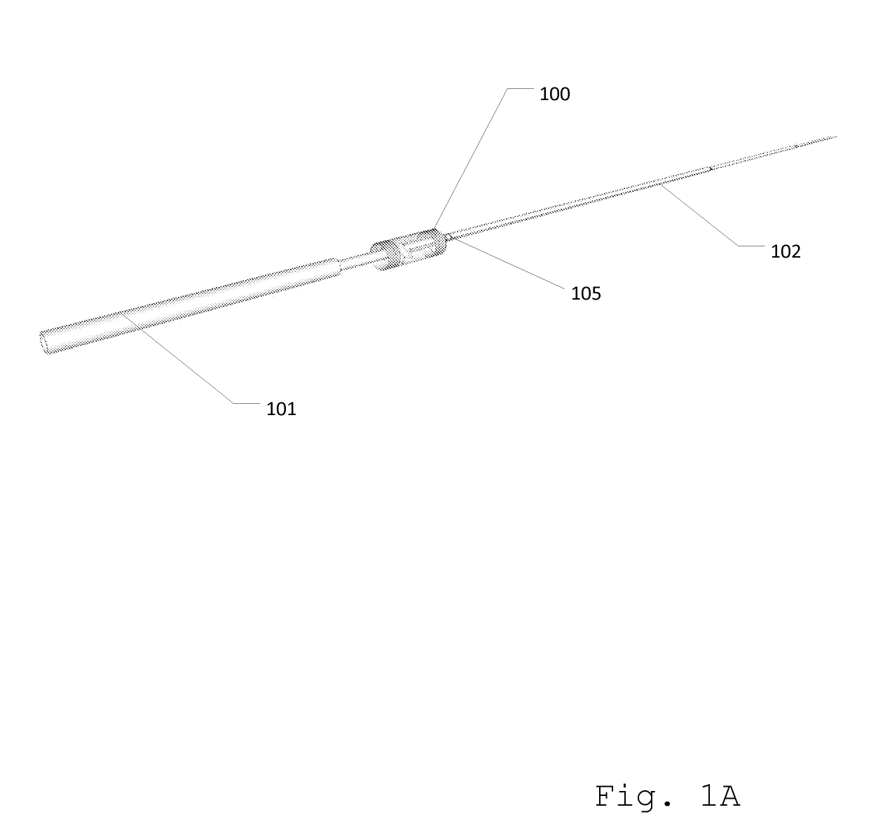

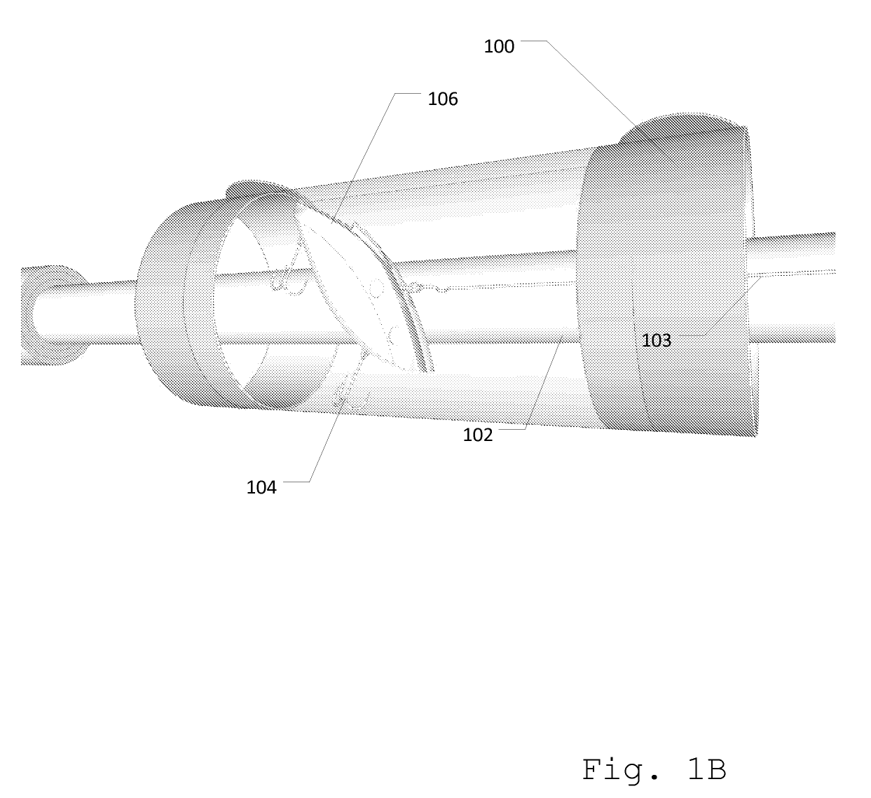

FIG. 1A illustrates a hook guard 100 attached to a fishing rod 101. Fishing rod 101 can comprise rod 102, a fishing line 103, a hook 104, one or more guide rings 105, and/or a lure 106. For purposes of this disclosure, fishing rod 101 can be any type of casting tool used to catch fish. Rod 102 can be a long, straight and flexible pole used for casting. Furthermore, rod 102 can be made from any materials which include, but are not limited to, wood, fiberglass and/or graphite. Likewise, fishing line 103 can be any type of string or cord attached to the fishing rod. Moreover, hook 104 can be attached at the end of fishing line 103. In one embodiment, hook 104 can be directly attached to fishing line 103. In another embodiment, one or more hooks 104 can be attached to a sinker or a lure 106. Additionally, sinker lure 106 can be attached to fishing line 103. As a result, hook 104 can be clasped to the guide ring 105 to ensure that fishing line 103 and hook 104 is not loose and does not get easily tangled.

FIG. 1B illustrates a close up view of a hook guard 100. As shown in FIG. 1, hook guard 100 can wrap around fishing rod 101, enclosing lure 106, hooks 104, and rod 102 within it.

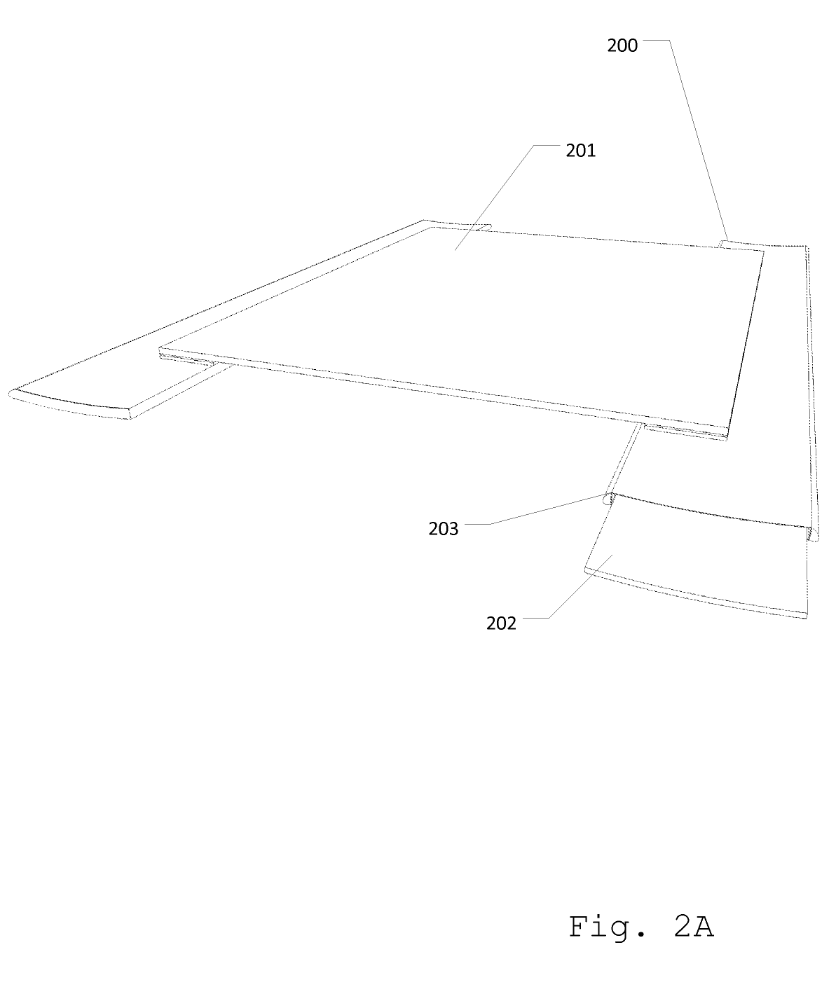

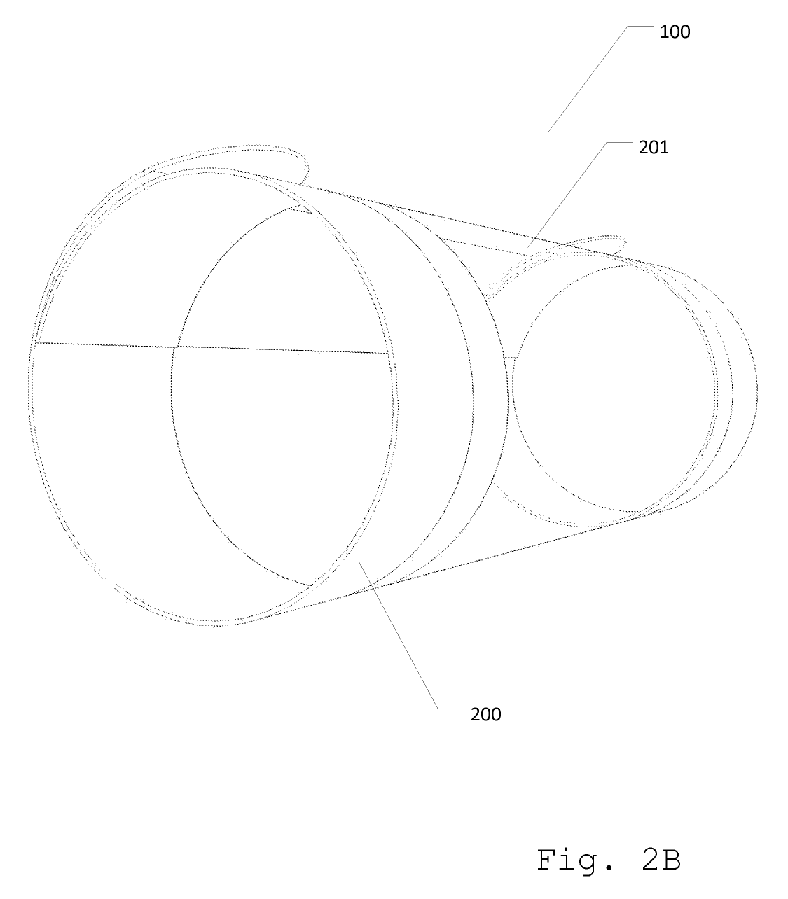

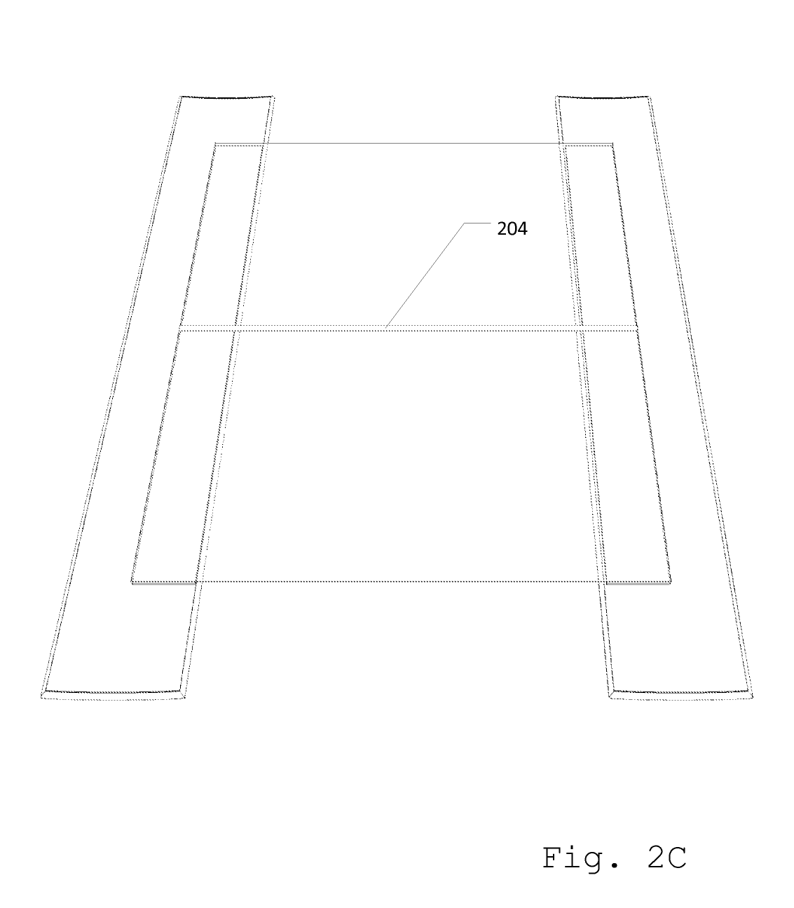

FIG. 2A illustrates a partially exploded view of hook guard 100. Hook guard 100 can comprise a slap bracelet 200 and a sheet 201. Slap bracelet 200 can comprise an insert 202 and, in some embodiments, a cover 203 as well. Insert 202 can comprise any metal, plastic or other material capable of having two states, as discussed below. For purposes of this device, cover 203 can comprise, but is not limited to, fabric, rubber, and/or plastics. cover 203 can be used to shield insert 202 from getting wet, stained and/or sustaining other forms of degradation. Accordingly, the lifespan of hook guard 100 is prolonged by cover 203.

Furthermore, FIG. 2A illustrates hook guard 100 and bracelet 200 in a flat state, where the bracelet 200 maintains a rigid position. Insert 202 has the capability of sustaining a flat state before contact with objects external to bracelet 200.

FIG. 2B illustrates hook guard 100 in a curved state. For purposes of this device, slap bracelet 200 can be any flexible material that is capable of having two stable mechanical states: a flat state and a curved state. At flat state, bracelet 200 is linearly straight, but can comprise a bend width-wise. However, once bracelet 200 is slapped or comes into contact against any object with sufficient force, slap insert 202 can spring into curved state, sometimes wrapping around the object in contact. Cover 203 can bend with insert 202 to the degree insert forms curved shape.

Correspondingly, sheet 201 can be any thin sheet material that can bend with slap bracelet 200. In one embodiment, sheet 201 can be waterproof. Further, in one embodiment, sheet 201 can be composed of materials which include, but are not limited to, fabric, rubber, wax and/or plastic. As applicable, sheet 201 can be sized to work with any size slap bracelet 200 such that sheet 201 makes at least one complete circle when bent by slap bracelet 200. Sheet 201 can be transparent, translucent, or opaque, and have any kind of color and texture with various types of engravings and/or print and decorations on its visible surface. Further, sheet 201 can be waterproof. Sheet 201 can connect to slap bracelet 200 in a number of ways, as illustrated in the following exemplary embodiments. In one embodiment, hook guard 100 can comprise two or more slap bracelets 200 connected to opposite ends of sheet 201. Slap bracelets 200 can be connected to sheet 201 through the use of adhesives, sewing, hook and loop fasteners, and/or other known connection fastening means. Sheet 201 can be connected to either side of slap bracelet 200 or along the edge of slap bracelet 200.

FIG. 2C illustrates an embodiment of hook guard 100 wherein hook guard 100 further comprises a rigid support 204. Rigid support 204, in one embodiment, can rest across sheet 201 perpendicular to slap bracelet 200.

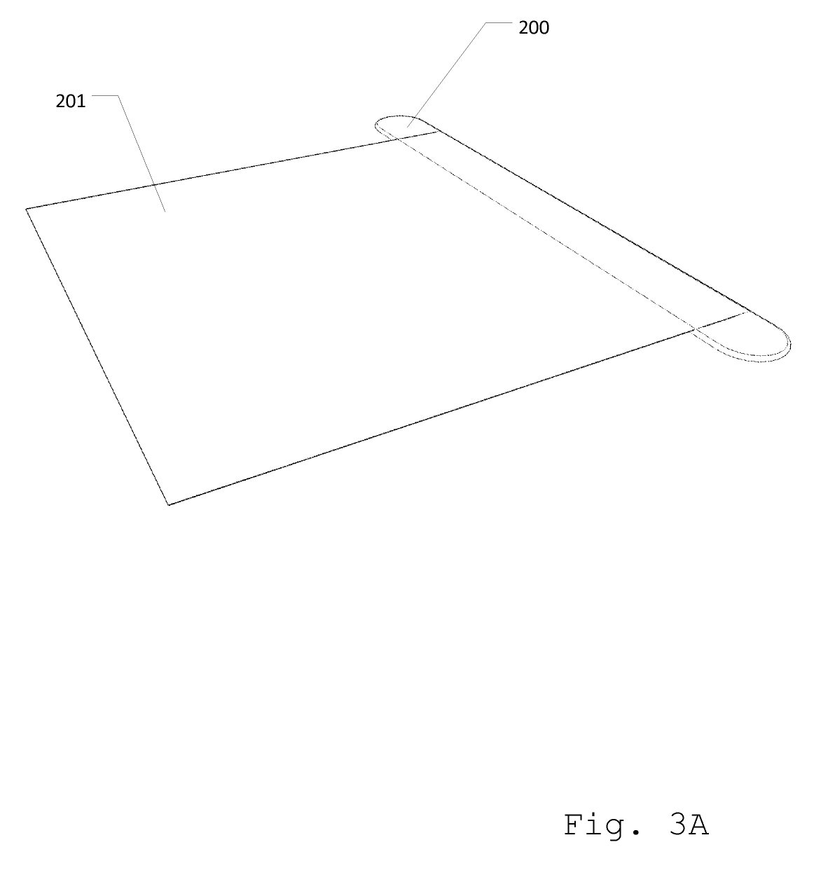

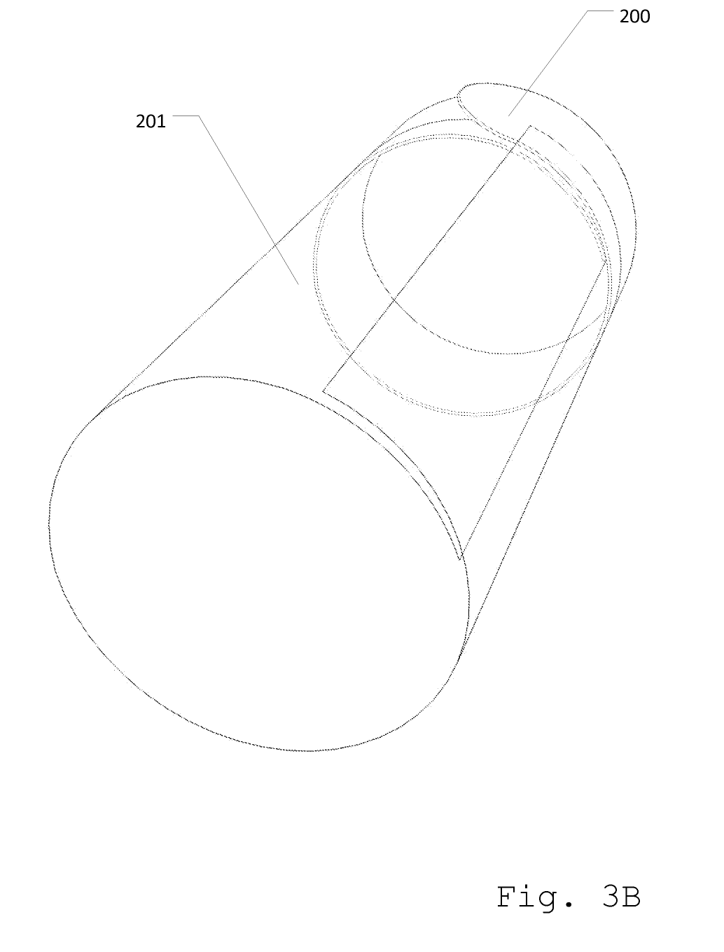

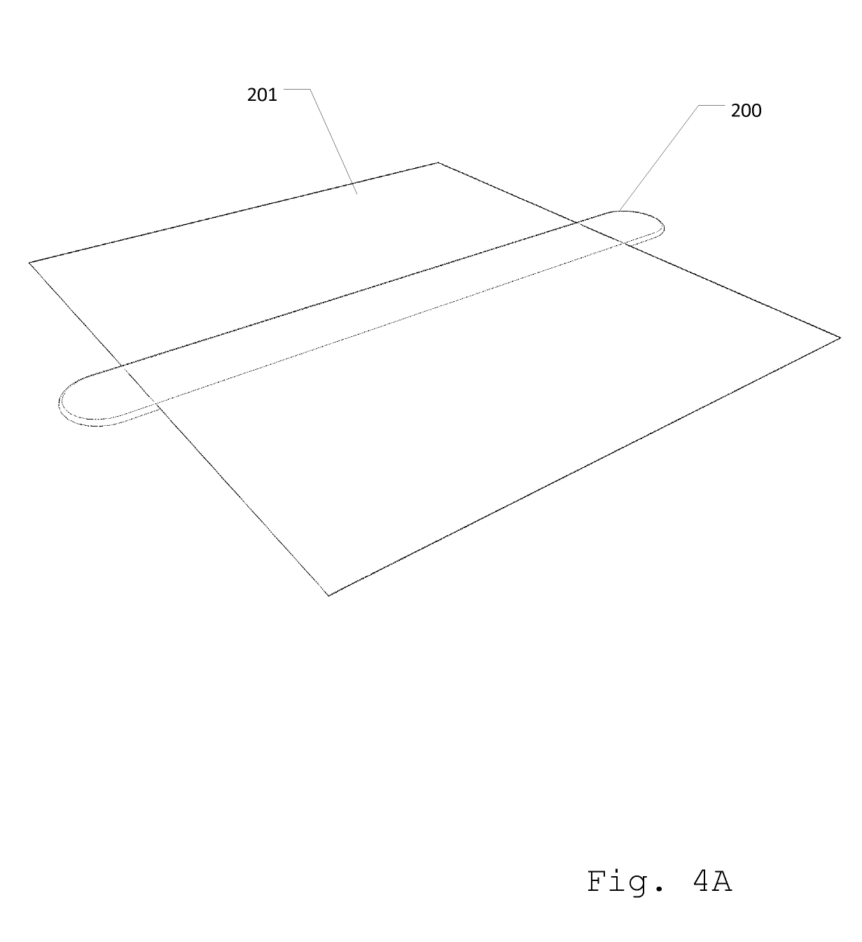

FIG. 3A illustrates an embodiment of hook guard 100 in a flat state that comprises one slap bracelet 200 on the end of sheet 201. In such embodiment, slap bracelet 200 can be connected to end of sheet 201. Sheet 201 can be connected to the convex or concave side of slap bracelet 200. Furthermore, in such embodiment, slap bracelet 200 can be attached at either end of sheet 201, as seen in FIG. 3A. In this embodiment, slap bracelet 200 can be placed at one end of sheet 201 and hook guard 100 can still form curved state, as seen in FIG. 3B. Accordingly, slap bracelet 200 curves around fishing rod 101 and sustains curved state of hook guard 100, while sheet 201 follows the contour and forms cylindrical shape. In such state, fishing tackles, such as lure 106, hooks 104, and rod 102, can be wrapped inside cylindrical shape of sheet 201, as slap bracelet 200 maintains the curved state of hook guard 100. Hence, the end of sheet 201 opposite to bracelet 200 can be loose, yet still maintain a curved, rigid cylindrical form when wrapped around an object. Thus, sheet 201 can still hold fishing gear securely in place. The size of sheet 201 can be increased or decreased in manufacturing to an appropriate amount of surface area for adequate coverage by hook guard 100 for particular fishing gear. Finally, hook guard 100 can be easily removed from fishing rod 101 by opening hook guard to an open state.

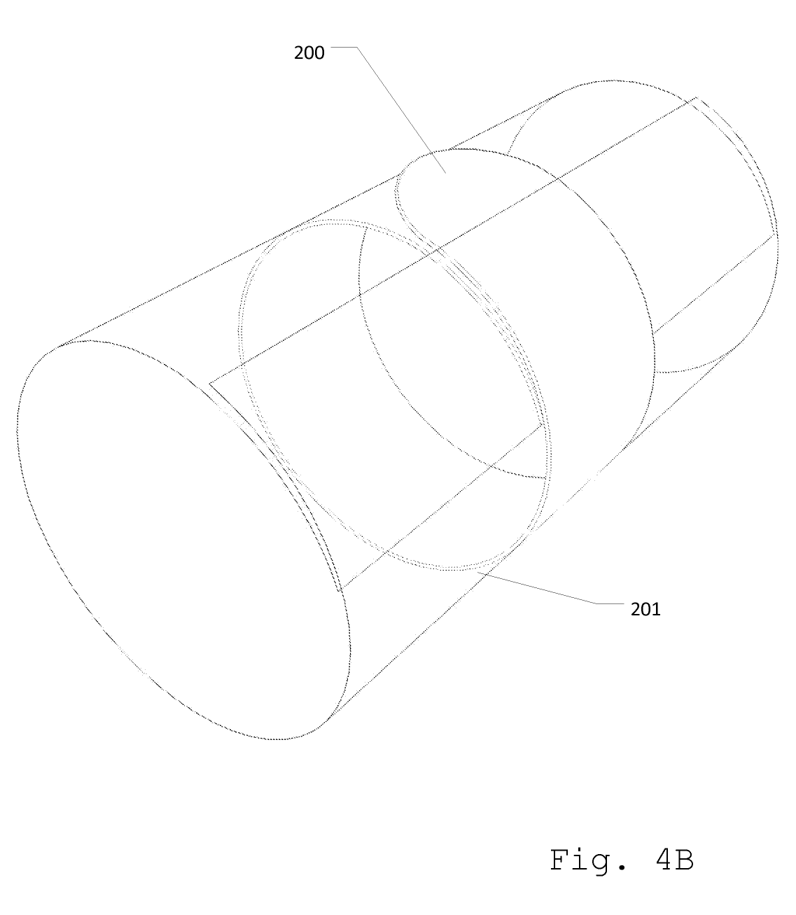

FIG. 4A illustrates an embodiment of hook guard 101 in flat state that comprises one slap bracelet 200 which is placed at the middle of sheet 201. Bracelet 200 placed at the middle can be slapped against the fishing rod and/or fishing tackles. As such, slap bracelet 200 can wrap around fishing rod 101 which can wrap fishing tackles such as lure 106, hooks 104 and rod 102 securely. Subsequently, fishing gears are wrapped in between slap bracelet 200, while sheet 201 can be used as an extended guard that ensures other fishing gear are still protected from hooks.

FIG. 4B illustrates an embodiment of hook guard 100 in a curved state. Because bracelet 200 is placed in the middle, the opposite ends of sheet 201 can be loose, but still hold a cylindrical shape around an object. In another embodiment slap bracelet 200 can be placed at any point on sheet 201 between the opposite ends, as well as diagonally or any angle relative to the ends of sheet 201 for adequate coverage of objects attached to rod 100.

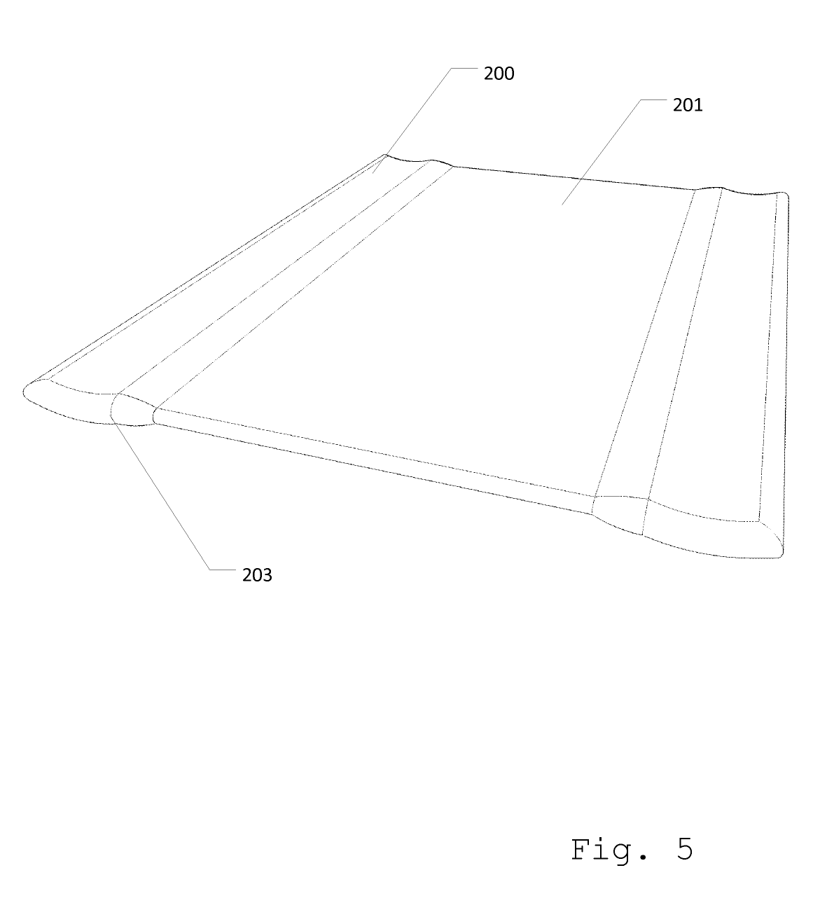

FIG. 5 illustrates an embodiment of hook guard 100 wherein bracelets 200 are attached on the outer edges of sheet 201 such that cover 203 and sheet 201 form a solid, singular body (unibody). In such embodiment, hook guard 100 can be more sturdy, and, if sheet 201 and cover 203 are impermiable, more waterproof. Sheet 201 and cover 203 can comprise rubber, plastic, fabric or any other flexible material.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A hook guard system for securing fishhooks comprising
a sheet; and
a slap bracelet connected to said sheet, said slap bracelet comprising an insert, said insert having a flat state and a curved state.

2. The hook guard system in claim 1, wherein said slap bracelet further comprises a cover around said insert.

3. The hook guard system in claim 1, wherein said sheet is connected to said cover using an adhesive.

4. The system of claim 3, wherein said cover is connected to the middle of said sheet.

5. The system of claim 3, in which said slap bracelet is connected at an end of said sheet.

6. The system of claim 5, comprising a second slap bracelet connected to a second end of said sheet.

7. The hook guard system of claim 1, wherein said sheet and said cover are unibody.

8. The hook guard system of claim 1, wherein a rigid stick is connected to said sheet, perpendicular to said bracelet.

9. The system in claim 8, wherein said rigid stick is adhered to the middle of sheet.

10. The system in claim 8, wherein said rigid stick is connected to an end of sheet

11. The system in claim 8, comprising a second bracelet attached to said sheet, parallel to said bracelet.

12. A method for securing hooks comprising
wrapping a hook in a hook guard,
said hook guard comprising
a sheet; and
a slap bracelet connected to said sheet, said slap bracelet comprising an insert, said insert having a flat state and a curved and state.

13. The method in claim 12, wherein said slap bracelet further comprises a cover around said insert.

14. The method in claim 13, wherein said sheet is connected to said cover using an adhesive.

15. The method in claim 14, wherein said cover is connected to the middle of said sheet.

16. The method in claim 14, wherein said slap bracelet is connected at an end of said sheet.

17. The method in claim 16, comprising a second slap bracelet connected to a second end of said sheet.

18. The method in claim 12, wherein said sheet and said cover are uni-body.

19. The method in claim 12, wherein a rigid stick is connected to said sheet, perpendicular to said bracelet.

20. The method in claim 19, wherein said rigid stick is adhered to the middle or end of said sheet and/or a second bracelet is attached to said sheet, parallel to said bracelet.
